(19) United States
(12) Patent Application Publication
(10) Pub. No.: US 2005/0183956 A1
(43) Pub. Date: Aug. 25, 2005

(54) Electrodialysis device

(76) Inventor: Apostolos Katefidis, Gartringen (DE)

Correspondence Address: King & Jovanovic, PLC, 170 College Avenue, SUITE 230, HOLLAND, MI, 49423, US

(21) Appl. No.: 10/745,932

(22) Filed: Dec. 24, 2003

(30) Foreign Application Priority Data
Dec. 27, 2002 (DE) 102 61 275.7

(51) Int. Cl. C02F 1/469; G01N 27/26; B01D 59/50; B01D 61/56

(52) U.S. Cl. 204/520

(57) ABSTRACT

An electrodialysis device (10), which, in particular, is employed for the purpose of adjusting the pH value of the lacquer liquid in a cataphoretic dip-lacquering plant, comprises a plurality of electrodialysis cells (16, 17) connected to one another in parallel, which in known manner each have two chambers (14) separated from one another by an ion-specific membrane (34). The individual electrodialysis cells (16, 17) are constructed analogously to one another and are arranged in a stack. They are each composed of plate-like elements (20a, 20b, 22a, 22b, 34) arranged alongside one another. Plate-like elements (20a, 20b) of a first type form electrodes, whereas plate-like elements (22a, 22b) of a second type form spacing elements which have a recess in the interior region and in this way laterally delimit a chamber (14). Within each electrodialysis cell (16, 17) a sequence is formed which consists of one plate-like element (20a) of the first type and two plate-like elements (22a, 22b) of the second type with an ion-specific membrane (34) arranged in between. This electrodialysis device (10) can be assembled inexpensively from very few different parts and can be readily varied in its capacity through the choice of the number of electrodialysis cells (16, 17) in the stack.

The invention relates to an electrodialysis device having
a) a plurality of electrodialysis cells connected to one another in parallel, which
   aa) each have two chambers separated from one another by an ion-specific membrane,
   whereby
   ab) one of the chambers can be flowed through by a feed liquid, from which ions are extracted in the chamber and which leaves the chamber as filtrate,
   ac) the other chamber can be flowed through by an exchange liquid for absorbing the ions extracted from the feed liquid,
   ad) an anode is arranged in one of the two chambers, and a cathode is arranged in the other of the two chambers.

Electrodialysis devices are known in extremely diverse areas of application. They may be found, for example, in the field of lacquering technology, particularly in the field of cataphoretic dip lacquering, where electrodialysis devices are utilised for the purpose of adjusting the acid content of the lacquer liquid. In this connection several electrodialysis cells are generally employed, which for reasons of capacity are connected in parallel.

The manufacture of the known dialysis cells is relatively elaborate: the requisite membrane has had to be fixed in a container, in order to separate the two chambers of the dialysis cell from one another. Furthermore, the electrodes have had to be introduced in suitable form, and a uniform continuous flow both of the feed liquid, which after depletion leaves the dialysis cell as filtrate, and of the exchange liquid, which absorbs the ions extracted from the feed liquid, has had to be guaranteed. The parallel connection of the dialysis cells has been undertaken by external hoses, this being likewise elaborate and space-consuming.

The object of the present invention is to configure an electrodialysis device of the type specified in the introduction in such a way that the number of structural elements to be used is extensively reduced and a compact and space-saving design of the electrodialysis device can be achieved.

According to the invention, this object is achieved in that
b) the electrodialysis device is constructed from a stack of analogously constructed electrodialysis cells,
c) the electrodialysis cells are composed of plate-like elements arranged alongside one another, whereby
   ca) plate-like elements of a first type form electrodes,
   cb) plate-like elements of a second type form spacing elements which have a recess in the interior region and in this way laterally delimit a chamber,
   cc) a sequence is formed of one plate-like element of the first type and two plate-like elements of the second type with an ion-specific membrane arranged in between.

As a result of the formation of the electrodialysis cells from substantially only two types of plate-like elements (plus the membranes), the number of structural parts differing from one another is considerably reduced. The overall structure is also clearly simplified by the direct chaining of the individual plate-like elements and also of the electrodialysis cells formed by said elements. The assembly of these electrodialysis cells and of the electrodialysis devices constructed from them becomes cost-effective overall. The electrodialysis device according to the invention can be produced in practically arbitrary capacities, by the appropriate number of individual electrodialysis cells being lined up one after the other.

It is preferred if the electrodialysis cells are terminated by a second plate-like element of the first type, one of the two plate-like elements forming a cathode, and the other plate-like element forming an anode. In this way, the electrodes of the individual electrodialysis cells delimit the chambers thereof on one side, without an additional wall being required.

This embodiment of the invention can be developed further in particularly advantageous manner to the effect that at least some of the electrodialysis cells are arranged in alternating manner in reverse sequence in such a way that the electrodes are assigned, in each instance, to two adjacent electrodialysis cells. With this manner of construction, in which the electrodes belong to two adjacent electrodialysis cells, a reduction in the structural parts required again arises; furthermore, an electrical insulation between adjacent electrodes of different electrodialysis cells becomes superfluous.

The stack of electrodialysis cells formed in this way may be delimited on both sides by terminating plates. These terminating plates protect the structural components situated further inside, for example the adjacent electrodes, and represent, where appropriate, an electrical insulation towards the outside.

On at least one terminating plate, ports for the supply of feed liquid and exchange liquid and also for the drainage of filtrate and of enriched exchange liquid may furthermore be formed. In this way, the electrodialysis device may be linked in simple manner to the external liquid circuits.

In particular, it is possible that one of the terminating plates has all the ports. Alternatively, it is also conceivable that one terminating plate has the ports for the supply of exchange liquid and the drainage of filtrate, and the other terminating plate has the ports for the supply of feed liquid and the drainage of enriched exchange liquid. By this means, a type of countercurrent principle is obtained in which the direction of flow of the exchange liquid is contrary to that of the feed liquid.

But one terminating plate may have the ports for the supply of feed liquid and exchange liquid, and the other terminating plate may have the ports for the drainage of filtrate and enriched exchange liquid. With this configuration, the directions of flow of feed liquid and exchange liquid through the electrodialysis device coincide.

The stack of electrodialysis cells is preferably held together with the aid of fastening elements connecting the two terminating plates to one another. In this case, a compressive stress on the elements situated between the terminating plates is generated, in particular via the fastening elements. By virtue of this measure, a good abutment of the individual plate-like elements against one another and a good effect of the intermediate seals is achieved.

The fastening elements preferably penetrate the plate-like elements in a region outside the chambers, for which purpose the plate-like elements have bores which are orientated in alignment with one another.

In one embodiment of the invention the plate-like elements of the first type, which accordingly form the electrodes, have laterally projecting current-connecting lugs. These current-connecting lugs serve for easy contacting of the electrodes. In particular in this context, the current-connecting lugs may each have bores which are penetrated by an electrical conductor, an electrical contact between the conductor and the plate-like element being established via the abutment of the conductor against the current-connecting lug in the region of the bore. The electrodes having the same polarity are preferably connected to one another via a common electrical conductor which, in particular, may take the form of a rod.

In order to make this possible in straightforward manner, the current-connecting lugs may be arranged eccentrically, and the plate-like elements of the first type—that is to say, the elements forming electrodes—that have different polarity may be arranged in mirror-symmetric manner with respect to one another. In this way, it is possible for the current-connecting lugs pertaining to the same polarity to be easily connected to one another by a rectilinear conductor. By way of electrodes of different polarity, it is possible for the same plate-like elements to be inserted, which need to be inserted only “on change-over”.

Particularly preferred is that embodiment of the invention in which the plate-like elements (including the membrane) have four through-bores which are orientated in alignment with one another in a region outside the chambers, whereby in the case of plate-like elements of the second type—that is to say, the spacing elements—two of the through-bores are connected via branch channels to the recess which is formed in the interior region and which constitutes the chamber. In this way, the through-bores, in alignment with one another, of the plate-like elements form flow channels which penetrate the electrodialysis device from one end to the other, without external connections, for example in the form of hoses, being necessary.

In this connection it is particularly advantageous if the through-bores are arranged symmetrically at least with respect to a plane of symmetry of the plate-like elements. In this way, these plate-like elements can also be incorporated “on change-over” into the entire electrodialysis device, reducing the number of different parts.

It is furthermore preferred that, in the case of the plate-like elements of the second type, the spacing elements, two such through-bores are connected to the recess via branch channels arranged in non-mirror-symmetric manner in relation to one another. By this means, it is ensured that the chambers that are laterally delimited by the spacing elements are flowed through substantially diagonally.

The plate-like elements of the second type, which are adjacent to a plate-like element of the first type forming an anode, are preferably arranged in mirror-symmetric manner with respect to a mirror plane in relation to the plate-like elements of the second type, which are adjacent to a plate-like element of the first type forming a cathode. By virtue of the mere manner of orientation of the plate-like elements of the second type within the entire stack, it is accordingly possible to determine whether the interior space surrounded by this plate-like element serves for continuous flow with feed liquid or for continuous flow with exchange liquid.

In this connection it is particularly preferred that, in each electrodialysis cell,
a) a first through-bore is capable of being flowed through by feed liquid, and a second through-bore is capable of being flowed through by filtrate, the two through-bores being arranged in non-mirror-symmetric manner with respect to a mirror plane and forming a first pair of through-bores;
b) a third through-bore is capable of being flowed through by supplied exchange liquid, and a fourth through-bore is capable of being flowed through by drained exchange liquid, the two through-bores being arranged in non-mirror-symmetric manner with respect to the one mirror plane and forming a second pair of through-bores; and
c) the two pairs of through-bores are arranged in mirror-symmetric manner relative to one another with respect to the one mirror plane.

This embodiment of the invention combines in itself, in optimal manner, the advantages of the small number of different structural elements and the preferred diagonal flow through the individual chambers surrounded by the plate-like elements of the second type (spacing elements).

A seal should be arranged between plate-like elements of the first and second types arranged in immediately consecutive manner. This seal serves to prevent an escape of liquid from the interior of the chambers and also from the interior of the various channels formed by the aligned through-bores in the individual plate-like elements. Whether a seal also has to be arranged between the plate-like elements of the second type—that is to say, the spacing elements—and the membrane depends upon the type of membrane.

An exemplary embodiment of the invention will be elucidated in more detail in the following on the basis of the drawing; shown are:

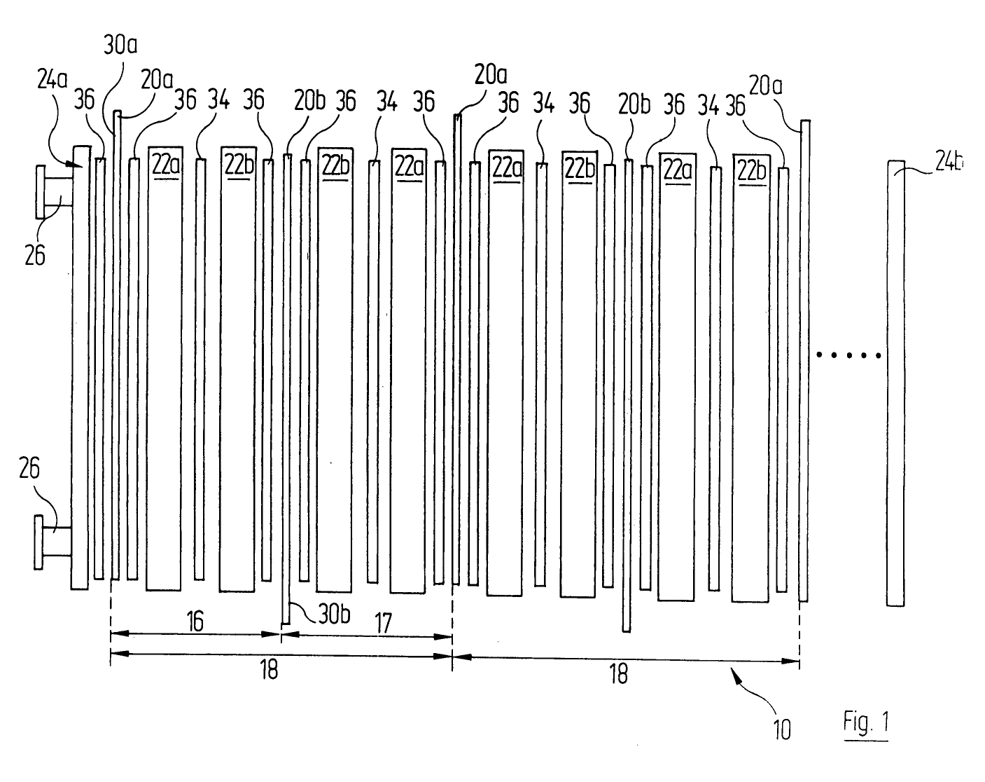

FIG. 1 a schematic lateral exploded view of an electrodialysis device according to the invention;

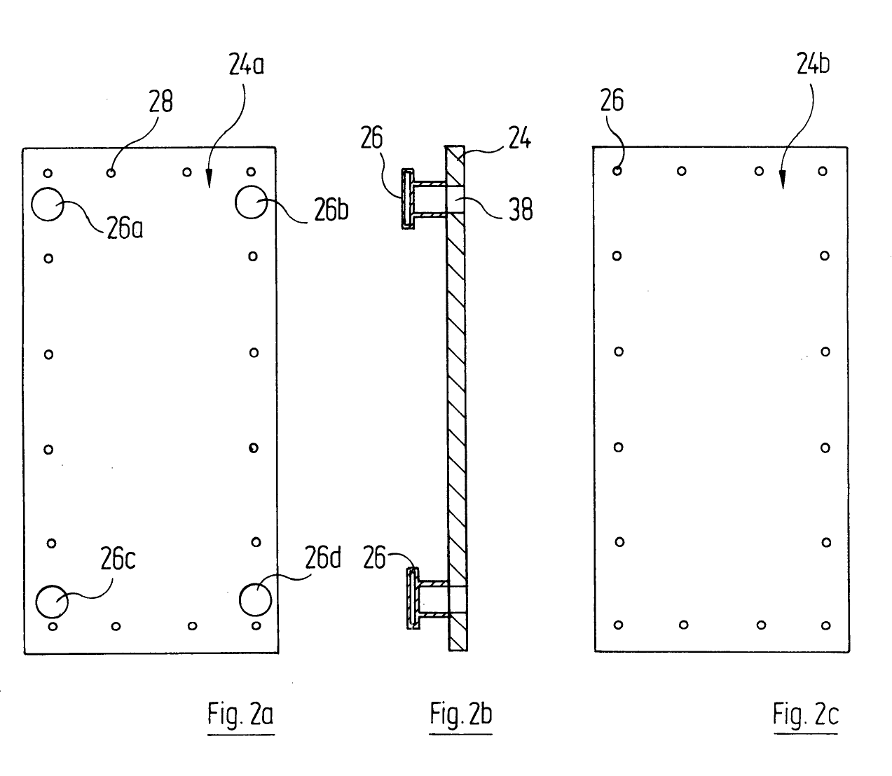

FIG. 2a the top view of a terminating plate of the electrodialysis device of FIG. 1;

FIG. 2b the side view of the terminating plate of FIG. 2a in section;

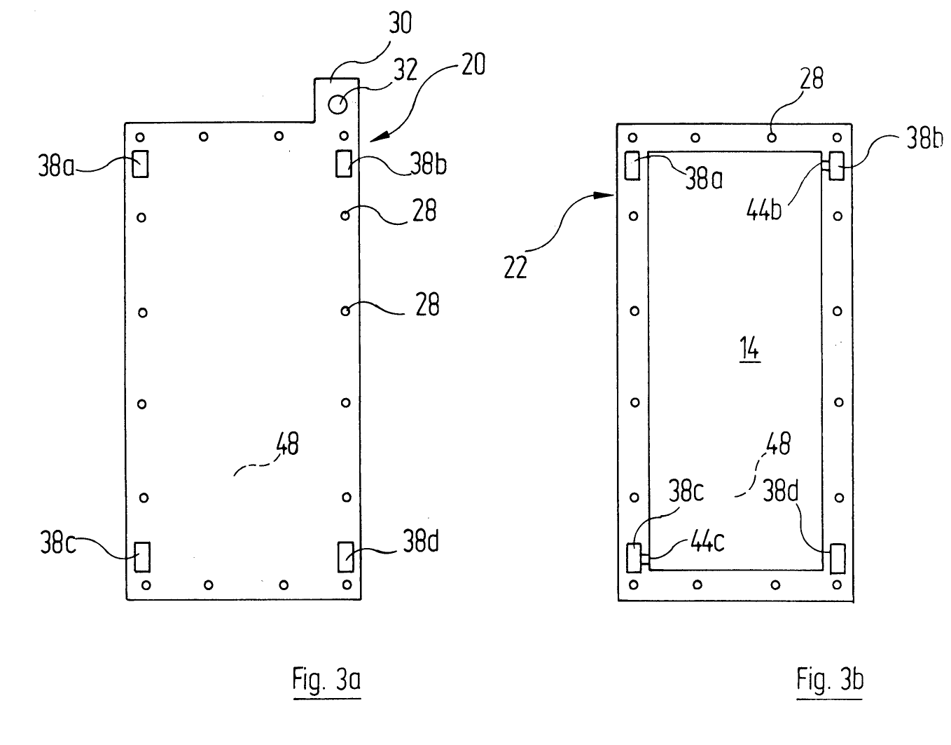

FIG. 3 the top view of the second terminating plate of the electrodialysis device of FIG. 1;

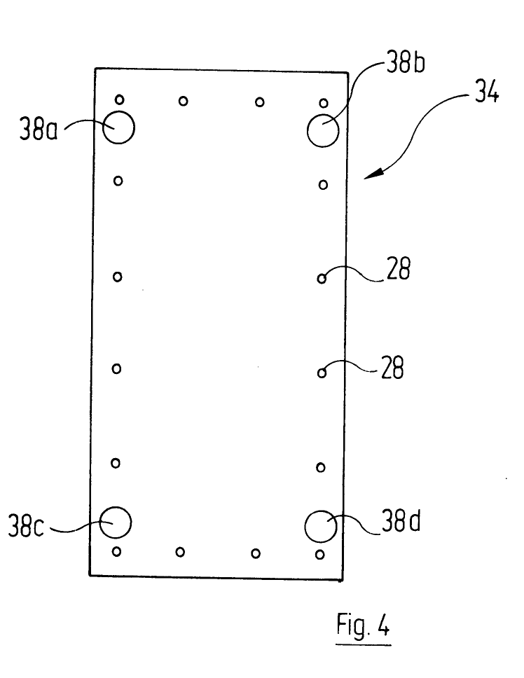

FIG. 4 the top view of an electrode plate as used in the electrodialysis device of FIG. 1;

FIG. 3b the top view of a spacing element of the electrodialysis device of FIG. 1;

FIG. 4 the top view of a membrane of the electrodialysis device of FIG. 1.

The electrodialysis device 10 which is represented in FIG. 1 in a schematic, lateral exploded view consists exclusively of a plurality of flat plate-like elements which are arranged between two lateral terminating plates 24a, 24b in the manner of a stack. The entire electrodialysis device 10 can be subdivided into double cells 18 which each comprise two electrodialysis cells 16, 17. FIG. 1 shows two such double cells 18—that is to say, a total of four dialysis cells 16, 17—which, as will become clearer further below, are connected in parallel as regards flow.

Each dialysis cell 16, 17 is delimited on both sides by a respective plate-like electrode 20a, 20b. These plate-like electrodes 20a, 20b are also called herein “plate-like elements of the first type”. The arrangement is such that adjacent interior electrodialysis cells 17, which accordingly are not immediately adjacent to a terminating plate 24, each share an electrode 20a, 20b. The dialysis cells 16, 17 comprise, in addition, two frame-like spacing elements 22a, 22b, between which an ion-specific membrane 34 is arranged. The spacing elements 22a, 22b are also called herein “plate-like elements of the second type”. Between the front ends of the spacing elements 22a, 22b facing away from the membrane 34 and the electrodes 20a, 20b adjacent to said spacing elements a seal 36 is inserted in each instance. A similar seal 36 is situated between the external electrodes 20a of the two external electrodialysis cells 16 and the terminating plates 24a, 24b adjacent thereto.

FIG. 2a shows the top view of the terminating plate 24a of the electrodialysis device 10 which is on the left in FIG. 1, via which the supply and drainage of the various liquids takes place. In the region of the “corners” of the rectangular terminating plate 24a there are provided, respectively, connecting sockets 26a to 26d which can be connected respectively to appropriate supply and drainage hoses or lines. The connecting socket 26a represented in the left upper corner in FIG. 2a serves for the drainage of filtrate—that is to say, of depleted feed liquid. The connecting socket 26b provided at the same level on the opposite side of the terminating plate 24a serves for the drainage of exchange liquid. The connecting socket 26c represented in the left lower corner of the terminating plate 24a in FIG. 2a serves for the supply of exchange liquid, whereas, lastly, the connecting socket 26d shown in the right lower corner of the terminating plate 24a serves for the supply of feed liquid—that is to say, of liquid to be depleted. The manner in which the internal flow paths of the two liquids proceed will become clear further below.

Along the edges of the terminating plate 24a there are provided, in addition, several through-bores 28 of smaller diameter, which, as will likewise become clear, serve for connection of the various elements of the electrodialysis device 10 with the aid of screws.

The terminating plate 24b on the right in FIG. 1, the top view of which is shown in FIG. 2c, possesses exclusively the small through-bores 28. It serves for closing the internal flow paths at the right end, in FIG. 1, of the electrodialysis device 10, for holding the entire electrodialysis device 10 together, and for electrical insulation of the adjacent anode 23.

FIG. 3a shows the top view of an electrode plate 20. The latter has the basic shape of a rectangle, with a likewise rectangular connecting lug 30 being attached onto the upper, narrow side of the rectangle. In alignment with the connecting sockets 26a to 26d of the terminating plate 24a, four through-bores 38a to 38d which are approximately rectangular in cross-section extend through the electrode plate 20. In addition, in the electrode plate 20 in FIG. 3a the through-bores 28 of small diameter can also again be discerned which serve for mutual connection of the various elements.

FIG. 3b shows the top view of a spacer 22. Said spacer has the form of a rectangular frame, the external dimensions of which correspond to the external dimensions of the base plates 24a and 24b and of the electrode plates 20 (with the exception of the connecting lugs 30). Once again, in alignment with the connecting sockets 26a to 26d and in alignment with the through-bores 38a to 38d of the electrode plate 20, four through-bores 38a to 38d are to be found. Whereas the through-bores 38a and 38d represented at the top left and bottom right in FIG. 3b are not connected to the recess surrounded by the frame of the spacing element 22, the through-bores 38b and 38c located opposite respectively on the same level are connected to this recess via short branch channels 44b and 44c, respectively. Once again, the through-bores 28 which have already been mentioned repeatedly are to be found in the spacing element 22.

FIG. 4 shows, in top view, a membrane 34, the external shape of which corresponds to the rectangular shape of the spacing elements 22 and also of the terminating plates 24a, 24b and (with the exception of the connecting lugs 30) of the electrode plates 20. The membrane 34 comprises four through-bores 38a to 38d which are in alignment with the through-bores 38a to 38d of the spacing elements 22 and of the electrode plates 20 and also with the connecting sockets 26a to 26d of the terminating plate 24a. The membrane 34 is also provided with the through-bores 28 of small diameter which are used for connecting the elements. The structural elements described above with reference to FIGS. 2a to 4, which all are substantially flat plate-like elements, are connected to one another to form the electrodialysis device 10 in the following way:

In addition to the terminating plate 24a bearing the connecting sockets 26, a first electrode 20 is fitted, with interposition of a seal 36, specifically in such a way that the connecting lug 30 is vertically upright. This electrode 20a is connected, in a manner to be described later, as an anode. To the anode 20a a spacing element 22a is applied, with interposition of a seal 36, specifically in such an orientation that the through-bore 38c communicating with the inner recess of the spacing element 22a is connected to the connecting socket 26a, and the through-bore 38b which likewise communicates with the recess is connected to the connecting socket 26b of the terminating plate 24a. The recess of the spacing element 22a is accordingly flowed through diagonally by exchange liquid.

The spacing element 22a is followed by a membrane 34, and this is followed in turn by a second spacing element 22b. But the latter is now inserted in a manner that is a mirror image in relation to the installed position of the first spacing element 22a: care is taken to ensure that the through-bore 38b of the spacing element is connected to the connecting socket 26a serving for the drainage of the filtrate, and the through-bore 38c is connected to the connecting socket 26d of the terminating plate 24a serving for the supply of the feed liquid. The recess of the spacing element 22b is accordingly flowed through by feed liquid, which leaves the spacing element 22b as filtrate.

The second spacing element 22b is followed, with interposition of a further seal 36b, by a second electrode plate 20b. The latter is now arranged in such a way that its connecting lug 30b points downwards. As will be elucidated later, it is connected as a cathode.

With the cathode 30b the first dialysis cell 16 is complete. Now the second dialysis cell 17 is attached alongside, to the right in FIG. 1. Said dialysis cell shares the cathode 30b with the first dialysis cell 16. Therefore a spacing element 22b, which has the same orientation as the spacing element 22b of the first dialysis cell 16, is attached onto the cathode 30b, with interposition of a seal 36. This accordingly means that in the case of this spacing element 22b the through-bores 38b and 38c, which are connected to the interior space via branch channels 44b and 44c, respectively, are connected to the connecting sockets 26a and 26d, respectively, of the terminating plate 24a—that is to say, they are flowed through by feed liquid and filtrate, respectively. Between this first spacing element 22b of the dialysis cell 17 and the second spacing element 22a of the same dialysis cell 17, a membrane 34 is in turn arranged. The orientation of the spacing element 22a of the dialysis cell 17 corresponds to that of the spacing element 22a of the dialysis cell 16; accordingly, it is such that its interior space 14 is connected to the connecting socket 26c for the supply of the exchange liquid and to the connecting socket 26b for the drainage thereof. With interposition of a further seal 36b, a further electrode plate 20a follows, the connecting lug 30 of which is directed upwards and which is connected as an anode. With this anode 20a the second dialysis cell 17 is completed. A second double cell 18 now begins, composed of two dialysis cells 16, 17, the manner of construction of which corresponds to the manner of construction, described above, of the first double cell 18.

The terminating plate 24b, which has no connecting sockets, is joined onto the final electrode 20a of the sequence of double cells 18, on the right in FIG. 1. The stack of plate-like structural elements obtained in this way is now held together by anchors or screws which are passed through the through-bores 28 of these various elements and on the ends of which, which are threaded, nuts are screwed.

All the connecting lugs 30a which project on one side from the stack of the structural elements and which pertain to anodes 20a are electrically connected to one another by a line (not represented) which is passed through the through-bore 32 of the connecting lugs 30 and is connected to the positive pole of a source of d.c. voltage.

Correspondingly, all the connecting lugs 30b projecting outwards on the opposite side and pertaining to the electrode plates 20b connected as cathodes are electrically connected to one another by a line which is not represented and which is passed through the through-bores 32 of these connecting lugs 30b and which is connected to the negative pole of the source of d.c. voltage.

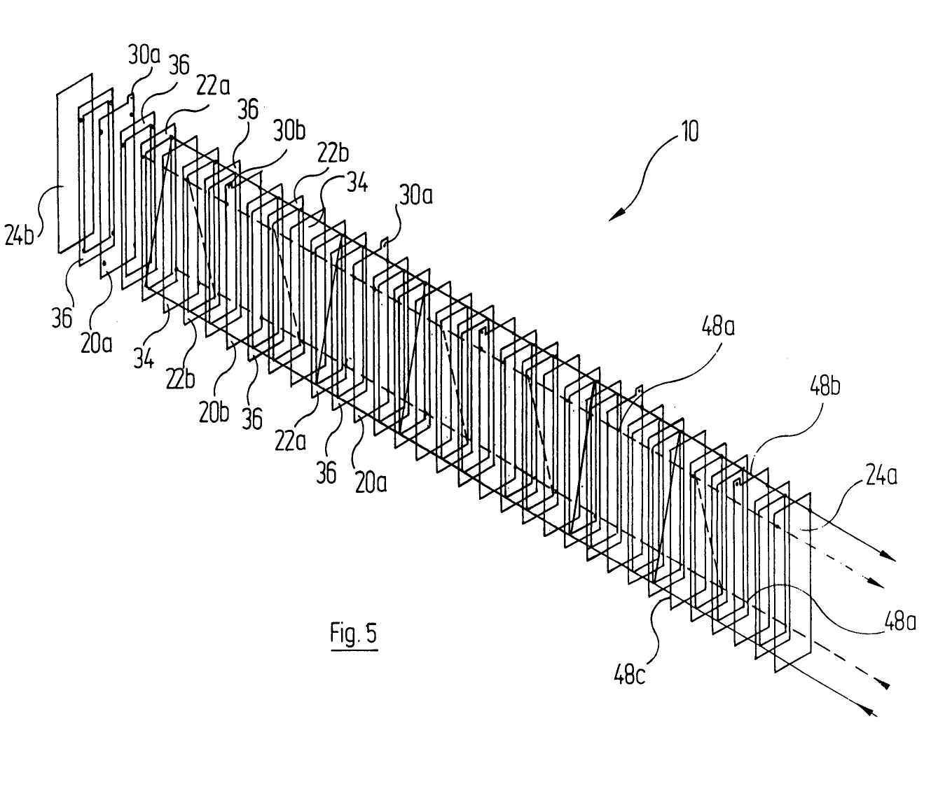

The flow paths of the various liquids within the electrodialysis device 10 described above are represented schematically in FIG. 5. From this Figure it can firstly be gathered that, by virtue of the through-bores 38a to 38d which are aligned with one another in the electrodes 20, in the spacing elements 22 and in the membranes 34, channels are formed which extend over the entire length of the electrodialysis device 10, which are closed at the end situated opposite the terminating plate 24a having the connecting sockets 26 by the terminating plate 24b, and which communicate with the connecting sockets 26a to 26d of the terminating plate 24a. The corresponding channels are provided in FIG. 4 with the reference symbols 48a to 48d. Filtrate is consequently drawn off via the channel 48a which is connected to the connecting socket 26a, and exchange liquid is drained off via the channel 48b which is connected to the connecting socket 26b. Exchange liquid is supplied via the channel 48c which is connected to the connecting socket 26c, and feed liquid is supplied via the channel 48d which is connected to the connecting socket 26d. By reason of the arrangement, described above, of the various plate-like elements, in particular taking account of the respective orientation of the spacing elements 22a, 22b, the following pattern of flow now arises.

The exchange liquid flowing in via the connecting socket 26c arrives via the channel 48c in the interior spaces of all those spacing elements 22a which are adjacent to an electrode plate 20a connected as an anode. The interior spaces 14 of these spacing elements 22a are flowed through in the diagonal direction. After ion absorption has taken place, the exchange liquid enters the channel 48b and leaves the electrodialysis device 10 via the connecting socket 26b.

The feed liquid, on the other hand, is introduced into the channel 48d via the connecting socket 26d of the terminating plate 24a. It flows through the interior spaces 14 of all those spacing elements 22b which are adjacent to an electrode plate 20b connected as a cathode. The feed liquid which has been depleted of ions is then conducted out of the electrodialysis device 10 via the channel 48a and the connecting socket 26a.

As can be discerned from the above description, the capacity of the electrodialysis device 10 can be enlarged as desired by appropriately frequent chaining of few structural components. All the liquid-conducting flow paths are formed within the electrodialysis device 10 itself, without any hose connections or other couplings being required for this purpose.

1. An electrodialysis device having comprising:
a) a plurality of electrodialysis cells connected to one another in parallel, which
aa) each have two chambers separated from one another by an ion-specific membrane,
whereby
ab) one of the chambers can be flowed through by a feed liquid, from which ions are extracted in the chamber and which leaves the chamber as filtrate,
ac) the other chamber can be flowed through by an exchange liquid for absorbing the ions extracted from the feed liquid,
ad) an anode is arranged in one of the two chambers, and a cathode is arranged in the other of the two chambers,
wherein
b) the electrodialysis device (10) is constructed from a stack of analogously constructed electrodialysis cells (16, 17),
c) the electrodialysis cells (16, 17) are composed of plate-like elements (20a, 20b, 22a, 22b, 34) arranged alongside one another, whereby
ca) plate-like elements (20a, 20b) of a first type form electrodes,
cb) plate-like elements (22a, 22b) of a second type form spacing elements which have a recess in the interior region and in this way laterally delimit a chamber (14),
cc) a sequence is formed of one plate-like element (20a) of the first type and two plate-like elements (22a, 22b) of the second type with an ion-specific membrane (34) arranged in between.

2. Electrodialysis device according to claim 1, wherein the electrodialysis cells (16, 17) are terminated by a second plate-like element (20b) of the first type, one of the two plate-like elements (20a) forming a cathode and the other plate-like element (20b) forming an anode.

3. Electrodialysis device according to claim 2, wherein at least some of the electrodialysis cells (16, 17) are arranged in alternating manner in reverse sequence in such a way that the electrodes (20a, 20b) are assigned respectively to two adjacent electrodialysis cells (16, 17).

4. Electrodialysis device according to claim 2, wherein the stack of electrodialysis cells (12) is delimited on both sides by terminating plates (24a, 24b).

5. Electrodialysis device according to claim 4, wherein the terminating plates (24a, 24b) are electrically insulating.

6. Electrodialysis device according to claim 4, wherein ports (26) for the supply of feed liquid and exchange liquid and also for the drainage of filtrate and enriched exchange liquid are formed on at least one terminating plate (24a).

7. Electrodialysis device according to claim 6, wherein one of the terminating plates (24a) has all the ports (26).

8. Electrodialysis device according to claim 6, wherein one terminating plate has the ports for the supply of exchange liquid and the drainage of filtrate and the other terminating plate has the ports for the supply of feed liquid and the drainage of enriched exchange liquid.

9. Electrodialysis device according to claim 6, wherein one terminating plate has the ports for the supply of feed liquid and exchange liquid and the other terminating plate has the ports for the drainage of filtrate and of enriched exchange liquid.

10. Electrodialysis device according to claim 1, wherein the stack of electrodialysis cells (16, 17) is held together with the aid of fastening elements connecting the two terminating plates (24a, 24b) to one another.

11. Electrodialysis device according to claim 10, wherein the fastening elements generate a compressive stress on the elements situated between the terminating plates (24a, 24b).

12. Electrodialysis device according to claim 10, wherein the fastening elements penetrate the plate-like elements (20a, 20b, 22a, 22b, 34) in a region outside the chambers (14), for which purpose the plate-like elements (20a, 20b, 22a, 22b, 34) have bores (28) which are orientated in alignment with one another.

13. Electrodialysis device according to claim 1, wherein the plate-like elements (20a, 20b) of the first type have laterally projecting current-connecting lugs (30a, 30b).

14. Electrodialysis device according to claim 13, wherein the current-connecting lugs (30a, 30b) each have bores (32) which are penetrated by an electrical conductor, an electrical contact between the conductor and the plate-like element (20a, 20b) being established via the abutment of the conductor against the current-connecting lug (30) in the region of the bore (32).

15. Electrodialysis device according to claim 13, wherein the electrodes having the same polarity are connected to a common electrical conductor which, in particular, takes the form of a rod.

16. Electrodialysis device according to claim 15, wherein the rod-shaped electrical conductor is part of a fastening element connecting the terminating plates (24a, 24b) to one another.

17. Electrodialysis device according to claim 1, wherein the plate-like elements of the first type (20a, 20b) having different polarity are arranged in mirror-symmetric manner relative to one another.

18. Electrodialysis device according to claim 1, wherein in a region outside the chambers (14) the plate-like elements (20a, 20b, 22a, 22b, 34) have four through-bores (38a, 38b, 38c, 38d) which are orientated in alignment with one another, whereby in the case of plate-like elements (22a, 22b) of the second type two of the through-bores (38b, 38c) are connected by means of branch channels (44a, 44b) to the recess which is formed in the interior region and which constitutes the chamber (14).

19. Electrodialysis device according to claim 18, wherein the through-bores (38) are arranged symmetrically at least with respect to a plane of symmetry of the plate-like elements (20a, 20b, 22a, 22b, 34).

20. Electrodialysis device according to claim 19, wherein in the case of the plate-like elements of the second type (22a, 22b) two such through-bores (38b, 38c) are connected-to the recess by means of branch channels (44a, 44b) which are arranged in non-mirror-symmetric manner relative to one another.

21. Electrodialysis device according to claim 19, wherein the plate-like elements of the second type (22b), which are adjacent to a plate-like element of the first type (20b) forming an anode, are arranged in mirror-symmetric manner with respect to a mirror plane (48) relative to the plate-like elements of the second type (22a), which are adjacent to a plate-like element of the first type (20a) forming a cathode.

22. Electrodialysis device according to claim 21, wherein in each electrodialysis cell (16, 17)
a) a first through-bore is capable of being flowed through by feed liquid, and a second through-bore is capable of being flowed through by filtrate, the two through-bores being arranged in non-mirror-symmetric manner with respect to a mirror plane and forming a first pair of through-bores;
b) a third through-bore is capable of being flowed through by supplied exchange liquid, and a fourth through-bore is capable of being flowed through by drained exchange liquid, the two through-bores being arranged in non-mirror-symmetric manner with respect to the one mirror plane and forming a second pair of through-bores; and
c) the two pairs of through-bores are arranged in mirror-symmetric manner relative to one another with respect to the one mirror plane.

23. Electrodialysis device according to claim 1, wherein a seal (36) is arranged between plate-like elements (20a, 20b, 22a, 22b) of the first and second types arranged in immediately consecutive manner.
